(19) United States
(12) Patent Application Publication
(10) Pub. No.: US 2009/0145255 A1
(43) Pub. Date: Jun. 11, 2009

(54) PARALLEL KINEMATIC DEVICE

(76) Inventor: Franz Ehrenleitner, Altensteig-Walddorf (DE)

Correspondence Address: FRIEDRICH KUEFFNER, 317 MADISON AVENUE, SUITE 910, NEW YORK, NY, 10017, US

(21) Appl. No.: 11/989,445

(22) PCT Filed: Jul. 11, 2006
(86) PCT No.: PCT/AT2006/000296

§ 371 Date: Jan. 23, 2008

(30) Foreign Application Priority Data
Jul. 29, 2005 (AT) A 1284/2005

(51) Int. Cl. B25J 18/00

(52) U.S. Cl. 74/490.01; 901/28

(57) ABSTRACT

The invention relates to a parallel kinematic device with a fixed platform and with a moving platform based on rods (1, 11, 21, 41) and on actuators, at least one actuator (A, A1, A2) is provided in the form of a rod of a constant length with a foot (6, 16, 26, 46) that can move relative to the fixed platform and, with a rod of a constant length and fixed foot (1, 11, 21, 41) on the fixed platform, comprises a common head (2, 12, 22, 42) on the moving platform, and the retaining force remains largely independent of the angular position of the kinematic. The displaceable foot (6, 16, 26, 46) is guided along an arc of a circle by a steering rod (7, 17, 27, 49) with a fixed foot on the first platform, with which is connected in an articulated manner and it acts upon a point of application (10, 40) connected in a fixed manner thereto via a force introduction element (9, 49).

The invention concerns a parallel kinematic mechanism with a fixed platform and a moving platform that is based on rods and actuators, where at least one actuator is designed as a rod of constant length with a base support point that can be moved relative to the fixed platform and has a common upper support point on the moving platform with a rod of constant length and fixed base support point on the fixed platform.

Parallel kinematic mechanisms of this type are also referred to as scissors or pairs of sector arms and are generally known. In this regard, one of the two rods (or both of them) can extend beyond the upper support point without this impairing the kinematic characteristics of the mechanism. The fixed base support point is usually placed in a structure which is known as the “fixed platform” and represents a local inertial system or in any event a reference system assumed to be fixed. The movable base support point of the actuator is also moved relative to this system. The common upper support point of the mechanism is generally part of a so-called “moving platform”, with the term “moving” serving to distinguish it from the fixed platform and also to indicate the relative movement between these two platforms.

In most cases, the movement between the two platforms does not occur within a plane; in this case, a spatial kinematic mechanism is involved, and the present mechanism can also be part of a spatial kinematic mechanism of this type.

A kinematic mechanism of this type in accordance with the invention can be used as part of a single-stage or multistage, generally parallel kinematic mechanism or as one stage of a serial kinematic mechanism. In particular, the kinematic mechanism of the invention can be used in manipulator robots. Hereinafter, for the sake of better readability, only the term “kinematic mechanism” will be used, and this will be understood to mean the corresponding device of the invention.

A parallel kinematic mechanism with movement of the base support point is known, for example, from WO 03/004223 A, the contents of which are herewith incorporated in the contents of the present application by reference. This document is a comprehensive publication that concerns a rather remarkable device, namely, a centrally symmetric, parallel rod kinematic mechanism for a moving platform, which is actuated by base support point movement of six rods along rectilinear axes that run parallel to the central axis. In addition, the illustrated embodiment has a has a rotational mechanism for a tool platform on the moving platform. This serially designed rotational mechanism is actuated by a rotating rod and a motor via a suitable coupling. The authors also discuss the possibility of using kinematically redundant systems and base support point mechanisms in combination with variable-length actuators.

In detail, this mechanism is designed as follows: Six centrally symmetric vertical rails for moving the base support points are provided on the fixed platform. Three rods are constructed longer and three shorter. The shorter rods act on a “lower-lying” region of the moving platform and are offset from the longer rods by 60° around the central axis.

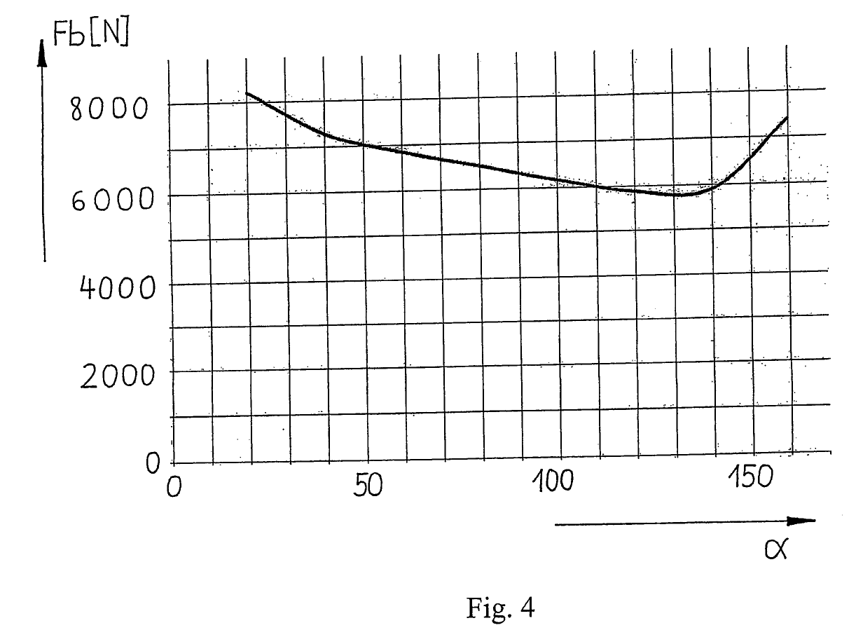

This results in a moving platform that can be moved essentially along the central axis, as is also shown by FIG. 4 of the cited document. It shows the arrangement of the configuration described above on a Stewart platform to make it more mobile, i.e., the serial coupling of two parallel kinematic mechanisms. Interestingly, however, in this embodiment, the motion of one of the parallel kinematic mechanisms is not used at all for the movement of the other, i.e., the entire movement of the second parallel kinematic mechanism is made on its own on the intermediate platform, so that only an aggregation is actually present here and not a combination.

Finally, only one operating range within the boundaries of the mechanism (e.g., areas above its base) can be swept over with this kinematic mechanism, i.e., this mechanism can be used as a machine tool or the like, but by no means can it be used or adapted as a manipulator robot or for the conveyance of objects.

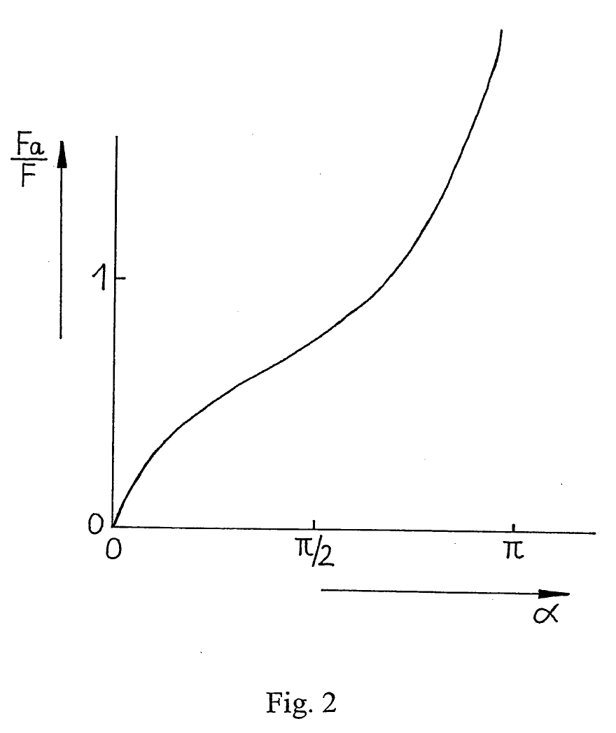

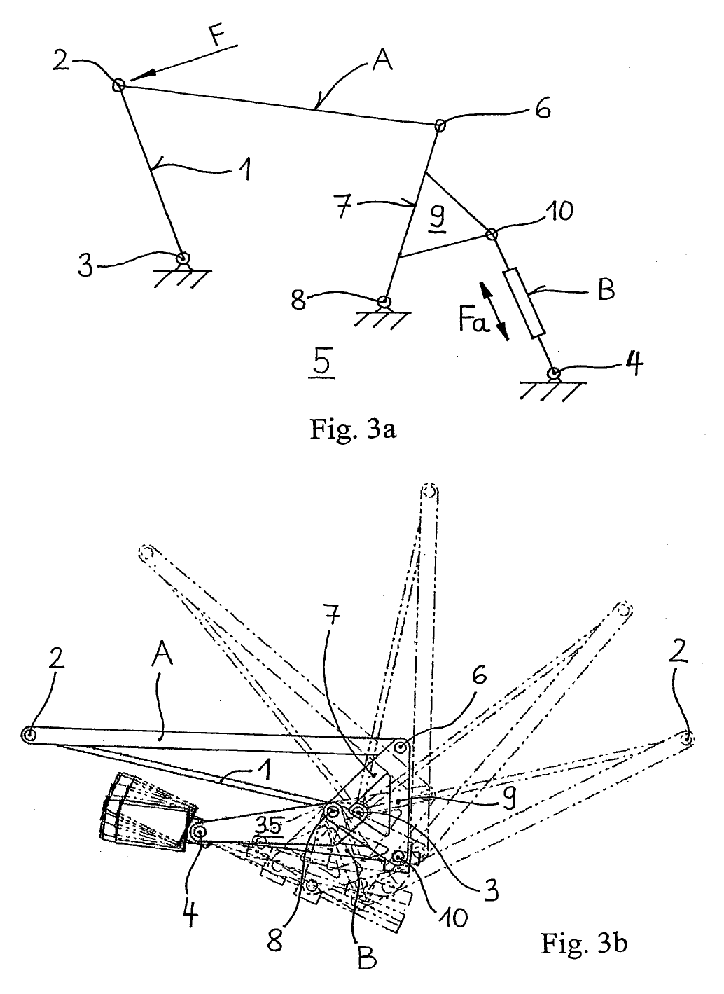

WO 03/059581 A, the contents of which are herewith incorporated in this application by reference, also concerns an original kinematic mechanism that operates on the basis of base support point movement, where rods on the actuators that effect the base support point movement sometimes have common base support points, which therefore undergo identical movements. These actuators operate in an essentially rotary manner, so that ultimately a serial element is again introduced into the kinematic mechanism by the special design of the base support point movement. This is also apparent from a comparison of FIGS. 2 and 3, since FIG. 3 shows the base support point movement in almost perfect analogy to WO 03/004223 A, which was discussed above.

Nothing exemplary can be derived from this document for the movement of relatively large loads or the transmission of relatively large forces, since the diversion of the forces between the movable base support points and the actuators that carry out this base support point movement and even more so between the levers that provide for the base support point movement and their holding rod is extremely unfavorable. This mechanism also cannot be used for relatively large operating ranges, because its relative space requirement (ratio of required work area/work volume) is very large.

Finally, we should also mention U.S. Pat. No. 5,378,282 A, whose device is based on base support point movement. In this connection, three legs acting on the moving platform close to one another are suitably positioned by worm drives. The moving platform is lengthened in the direction of the central leg and carries a tool on its (possibly curved) free tip. This device is thus a peculiar hybrid, since the position of the moving platform is defined by the position of the corresponding point of the central leg and its position. This device can be used only in narrowly bounded spaces and, due to the multiple force deflection, it is not suitable for large loads. This device also does not have pairs of sector arms according to the definition given at the beginning.

Ilian Bonev gives an excellent overview of the historical development and the principles of parallel kinematic mechanisms as well as a listing of the most important patents in the article “The True Origins of Parallel Robots” on the homepage http://www.parallemic.com of “The Parallel Mechanisms Information Center”.

On the other hand, there are designs that belong to planar kinematics and are often referred to simply as planar kinematics, which occur in technology often and in diverse forms. Due to their good ability to be represented graphically, due to the possibility of relatively simple computation of the equations of motion, due to the existing production processes, which make it possible to produce the required swivel joints precisely and inexpensively, and due to the nicely predeterminable dynamic conditions, planar kinematic mechanisms are used in machine tools, in power conversion machines, in hoisting machines, and even in manipulator robots, such that in most cases various systems of the planar kinematic mechanism are arranged in succession as an “open chain”, in order in this way to arrive, if desired, at spatial kinematic systems by a combination of planar kinematic systems of this type.

If, as is usual in many cases, one thinks of a planar kinematic mechanism of this type in simplest terms as being formed of one rod of constant length and one rod of variable length, such that the two base support points of the rods have a constant distance from each other and their upper support points coincide, such that all movements about the upper support points and the base support points represent rotations about axes normal to the plane defined by the two rods, then one immediately sees that, during the length variation of the actuator (that is the rod of variable length), a force of constant magnitude that is present at the upper support point in the plane (other forces are not treated here) and that always acts normally to the rod of fixed length requires very strongly variable opposing forces in the actuator, depending on the angular position of the rod of constant length in order for it to be possible for this load to be “held”. In this connection, the difference between the minimum necessary and the maximum necessary holding force can vary by a factor of 2 or more even with small changes in the angular position.

This great variation of the holding force is also accompanied by correspondingly great stress on the overall kinematic mechanism, the bearings, the base, and the rods, which necessitates correspondingly massive construction, which in turn results in a considerable increase in dead weight and thus in the minimum necessary drive power of the actuator.

In the prior art, an effort is made to counter these problems by selecting the length of the base and the position and shape of the force polygon in the region in which—depending on the field of application—either the greatest precision of movement is necessary or the greatest load can be expected in such a way that in this region the most favorable dynamic situation is present for the given case and that the operation is carried out in the less favorable ranges of movement either only with a reduced load or just as infrequently as possible, etc.

These restrictions are inconvenient especially, but not exclusively, in the case of manipulator robots, since they impair the universal utility of the robots, which makes it possible, by their free programmability, for one and the same robot, for example, to perform jobs “overhead” as well as laterally and at the bottom. In the case of spray painting robots, this is not overly disturbing due to the relatively low weight of the tool, but even for welding robots and especially for all robots that move parts, this constitutes a troublesome restriction.

The aim of the invention is to avoid the specified disadvantages of the prior art acknowledged above and to specify a possibly planar parallel kinematic mechanism in which the holding force necessary for holding a predetermined force acting on a moving part of the kinematic mechanism remains largely independent of the given instantaneous angular position of the kinematic mechanism.

In accordance with the invention, these goals are achieved by virtue of the fact that, in the parallel kinematic mechanism defined at the beginning, the movable base support point is guided along a circular arc by a connecting rod with a fixed base support point on the fixed platform, with which it articulates, and that an actuator acts on the connecting rod or on a point of application of force that is rigidly connected with the connecting rod by a force introduction element.

In this regard, it should be noted that the moving base support point of the actuator, corresponding to the upper support point of the connecting rod, is neither part of the fixed platform nor part of the moving platform but rather moves relative to the former along a circular arc.

The invention is explained in greater detail below with reference to the drawings.

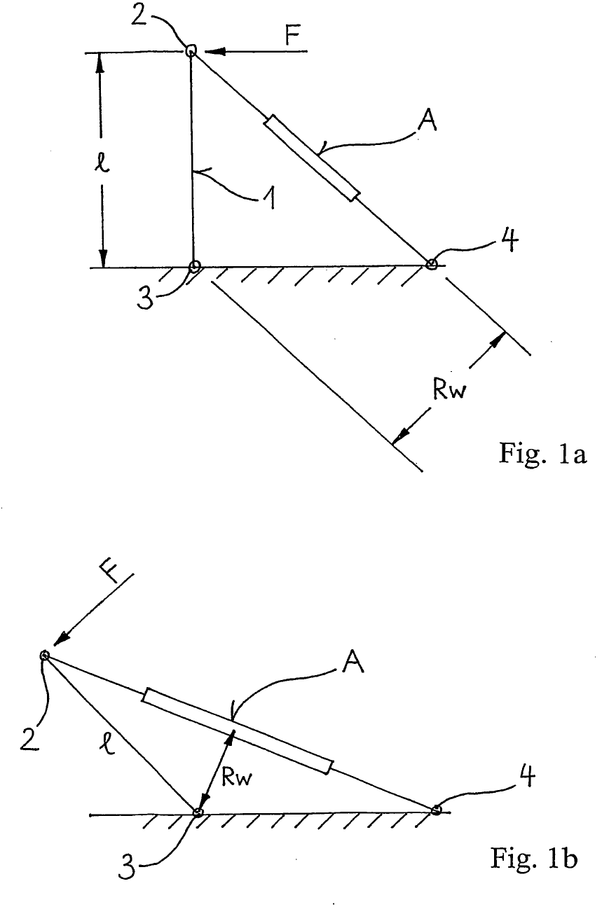

FIG. 1 shows a general planar force polygon in accordance with the prior art in two representations with different angular positions.

FIG. 2 shows a typical curve of the piston pressure at constant force F in FIG. 1.

FIG. 3a shows a highly schematically illustrated general kinematic mechanism in accordance with the invention.

FIG. 3b shows a first embodiment of a planar kinematic mechanism of the invention in three different positions.

FIG. 4 shows a graph of the force curve in the actuator analogously to FIG. 2 but for a kinematic mechanism according to FIG. 3b.

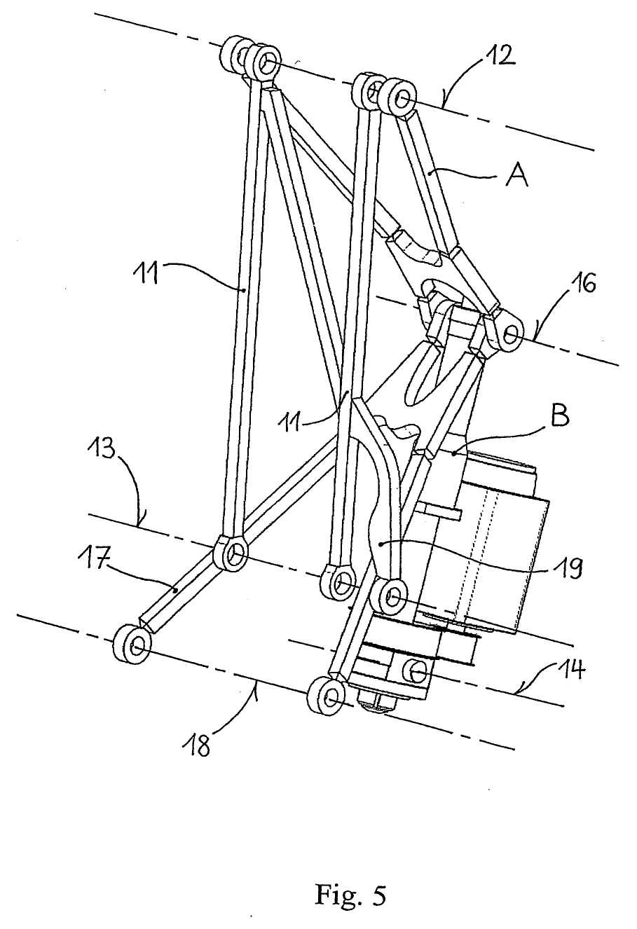

FIG. 5 shows a perspective view of a planar kinematic mechanism of the invention in an embodiment that can be used for a manipulator robot.

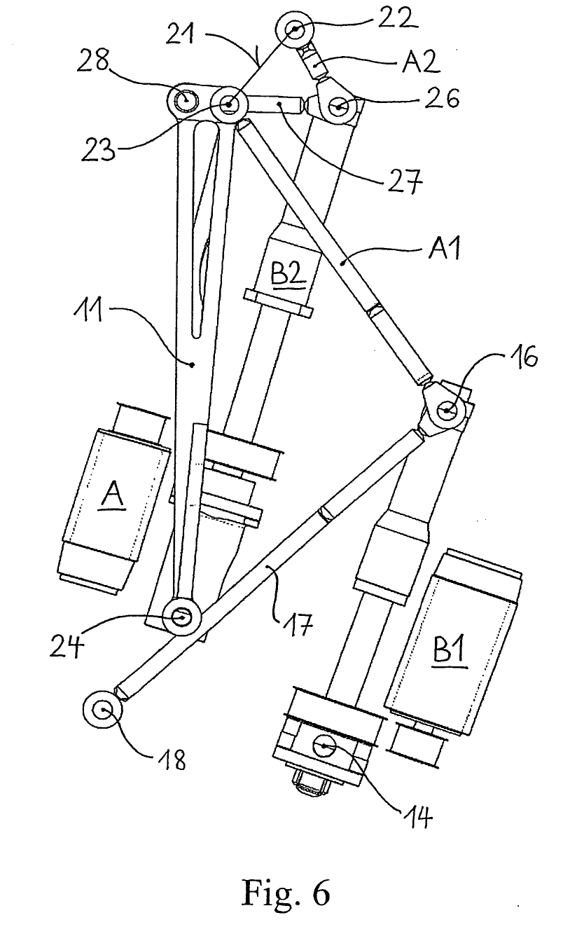

FIG. 6 shows a side view of the kinematic mechanism according to FIG. 4 with an additional kinematic mechanism of the invention arranged serially to it.

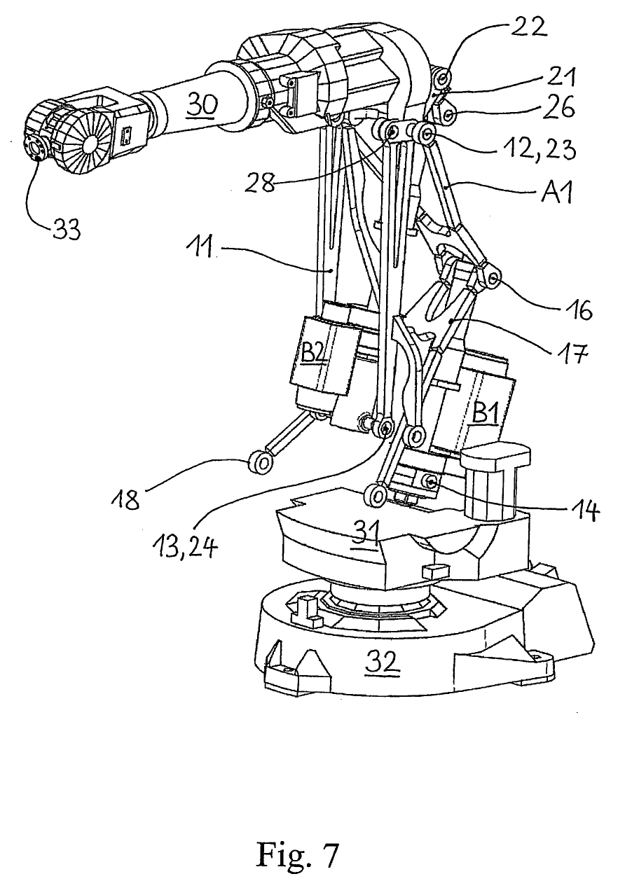

FIG. 7 shows a design of a manipulator robot with the kinematic mechanism of FIG. 6 in a perspective view.

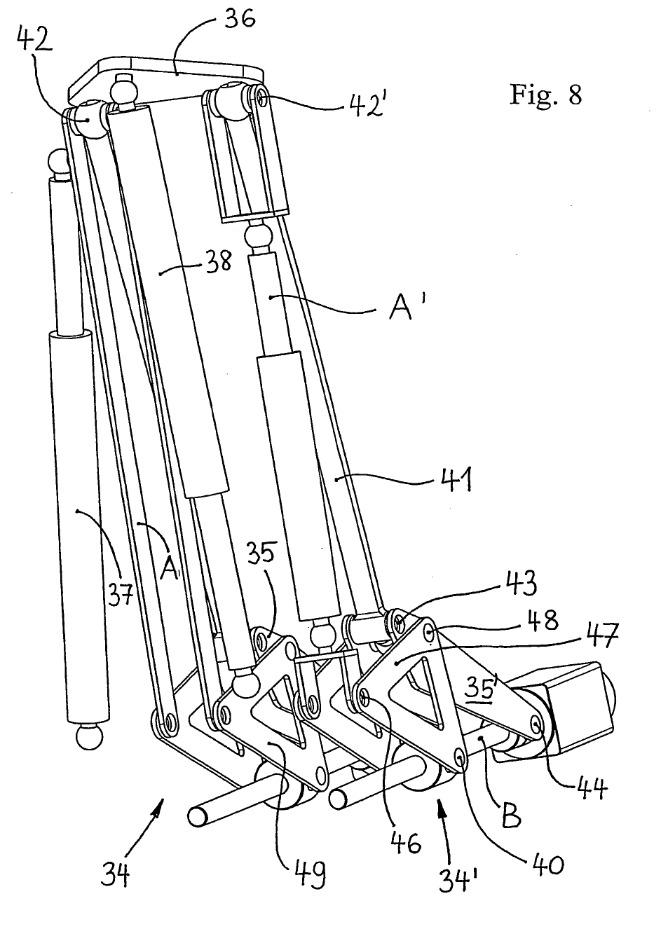

FIG. 8 shows the use of two planar kinematic mechanisms of the invention in an arrangement parallel to each other.

FIG. 1 shows a standard force polygon that consists of a rod 1 of constant length and an actuator A of variable length in two different angular positions. A force F, which acts at the common upper support point 2 and in the illustrated position acts with the lever arm 1 about the base support point 3, requires a force Fa in the actuator A, for which the following equation holds:

Fa=(F×1)/Rw

where Rw stands for the angle-dependent power arm of the actuator A about the base support point 3.

FIG. 1b shows the situation in the displaced state; the rod 1 still has the length l, and the force F is regarded as acting normal to the rod 1. As is apparent from the great reduction of the lever arm of the opposing force Fa in the actuator, the force to be exerted in the actuator A to hold the force F has become much greater. It is apparent that on further movement of the rod 1 about the base support point 3, a singularity is reached when the upper support point 2 comes into line with the base support points 3 and 4; at this point the now purely hypothetical holding force Fa would become infinitely large.

FIG. 2 is a purely schematic representation of the ratio of the holding force Fa in the actuator A and the force F, which always acts on the rod 1 in the peripheral direction, as a function of the angle α of the rod 1 with respect to the line connecting the two base support points 3, 4.

When the force F does not follow the rod 1 but rather has a constant direction, as, of course, is regularly the case especially with hoisting machines, then the curve takes a different course, but with unfavorable design of the force polygon with respect to the direction of the load F, the curve can also have singularities.

To avoid these problems, the invention now provides a planar kinematic mechanism, which basically has the design shown in FIG. 3, which comprises two parts, namely, FIG. 3a, which shows the principle of the mechanism, and FIG. 3b, which shows an actual variant.

FIG. 3a shows that the rod 1, with its base support point 3 and the upper support point 2, corresponds to the arrangement according to FIG. 1, but that the actuator A is another rod of constant length, which is attached at one end to the upper support point 2 and at the other end to a moving base support point 6, at which a connecting rod 7 of the planar kinematic mechanism also articulates. The end of the connecting rod 7 that faces away from the moving base support point 6 (which is the same as the upper support point of the connecting rod 7) in turn articulates with a stationary pivot 8 (the base support point of the connecting rod 7).

The upper support point 10 of an actuator B is then attached to the connecting rod 7 or to a force introduction element 9 that is rigidly connected with the connecting rod 7, and the other end of the actuator B is likewise attached to a stationary point of articulation, i.e., its base support point 4.

As is evident from a brief analysis of FIG. 3a, it is now possible, by suitable choice of the stationary points of articulation or base support points 4 and 8, by suitable choice of the length of the connecting rod 7 and the actuator A, and by suitable choice of the shape and size of the force introduction element 9, thereby establishing the upper support point 10 of the actuator B, to establish a relationship between a force F acting at the upper support point 2 and the holding force Fa in the actuator B necessary to neutralize the force F.

The kinematic advantages and above all the dynamic advantages gained in this way are so great that the additional expenditure on elements, compared to the previously known device according to FIG. 1, is of no consequence. For the purpose of more clearly demonstrating the basic idea of the invention, the space requirement of the mechanism was greatly exaggerated in the drawing shown in FIG. 3a. FIG. 3b shows how compactly and elegantly the actually feasible solutions are:

As is apparent from FIG. 3b, suitable choice of the shape and positions of a stationary bearing plate 35 (fixed platform), on which the points of articulation 3 and 8 of the rod 1 and the connecting rod 7, respectively, and the base support point 4 of the actuator B are formed, makes it possible to achieve a very compact design, which nevertheless opens a large access range of the upper support point 2 (part of the moving platform, which is not shown here) over almost 180° with respect to a spatially fixed coordinate system.

For a kinematic mechanism in accordance with the invention, FIG. 4 shows the force Fb as a function of the swivel angle, from which it is apparent that despite a swiveling range of the rod 1 of almost 180°, the holding force Fb in the actuator B varies from its mean value by only about 15%.

In a perspective view, FIG. 5 shows the use of the invention in a manipulator robot with one plane of symmetry for the most important components. The only components that do not obey the symmetry condition are those which serve to brace the mechanism in directions with a normal component to the plane of symmetry. The mechanism of the invention is realized here virtually in the plane of symmetry, since in reality the individual rods for increasing the mechanical stability run obliquely to the plane of symmetry. The axes of rotation, which define the movements, all run perpendicularly (normal) to the plane of symmetry, so that the individual components always move parallel to the plane of symmetry.

The axes of rotation of the individual rods were given the same designations as in FIG. 3a but prefixed with a “1”. The brace between the symmetrical rods 11 was not labeled; the additional brace with the third eye around the axis 13 was labeled as 19, which did not fit in with the stated scheme but is advantageous for the numbering system.

In the illustrated embodiment, the actuator B is attached directly to the joint 16 between the connecting rod 17 and the actuator A; the force introduction element 9 of FIG. 3a thus coincides with the shaft of this joint.

It is readily apparent that it is an easy matter to construct, for example, the connecting rod 17 as two separate rods and to design one of them as a variable-length actuator. Naturally, the bearings of the rods must then also be arranged in such a way that, when this actuator is operated, twisting and rotation of the other rods also occur; this can be accomplished, for example, by Cardan's suspensions or the like, as is well known in parallel kinematic mechanisms. In this simple way, the mechanism of the invention can even be used to create three-dimensional parallel kinematic mechanisms.

FIG. 6 shows a side view of the kinematic mechanism according to FIG. 5 and a second kinematic mechanism, which is constructed analogously to the first kinematic mechanism and is attached to the fixed axis 13 (FIG. 5) of the first kinematic mechanism, and by which a second degree of freedom in the form of a parallel kinematic mechanism is employed. The elements of this second parallel kinematic mechanism are labeled analogously to FIG. 3a but prefixed with a “2”, such that the elements that are also part of the first parallel kinematic mechanism remain in FIG. 5 without the labeling that would belong to them according to the drawing of the first kinematic mechanism. For example, in FIG. 6, the axis 13 of FIG. 5 is not provided with this reference number but rather with the reference number 24 that applies to the second kinematic mechanism.

The base of the second kinematic mechanism is given by the axes 23 and 28, which are formed on the rod 11, so that the rod 11 is to be regarded as the base for the second kinematic mechanism. The rod 27 between the axes 28 and 26 forms the connecting rod for the actuator A2. The rod 21, which is indicated only by a simple line between the axes 22 and 23, forms the rod of constant length of the parallel kinematic mechanism of the invention. The base support point of the actuator A2 is operated by an actuator B2, whose base support point is pivoted on the base support point of the rod 11, and whose other end is attached to the connecting axis between the actuator A2 and the connecting rod 27. Even small strokes of the actuator B2 produce relatively strong rotation of the connecting rod 25 and the rod 21.

FIG. 7 shows a perspective view of an embodiment of this type of double kinematic mechanism, which here takes the form of a manipulator robot with an arm 30 mounted on it, in which, however, for the sake of simplicity of the drawing, the axes of rotation and their bearings of the respective base support points are not drawn in. They are only indicated by the associated reference numbers. The arm 30 is rigidly connected with the actuator A2 (FIG. 6) and moves with it. The chassis 31 is mounted on a foundation 32 in such a way that it can be rotated about a vertical axis (not shown). A tool carrier 33, which is shown in a purely schematic way mounted on the arm 30, can be rotated about the longitudinal axis of the arm 30 and about a transverse axis. In this example of application, the parallel kinematic mechanism of the invention is thus installed as a separate segment in a serial kinematic mechanism.

The drawings reveal the simple construction and good accessibility to all of the elements of the kinematic mechanism of the invention, and the large operating ranges and operating angles that can be covered are apparent especially from FIG. 3b.

FIG. 8 shows in a perspective view an example of how kinematic mechanisms in accordance with the invention can be used in parallel arrangement in three-dimensional parallel kinematic mechanisms, where the reference numbers of the components that correspond to components in FIG. 3a were provided with a prefix of “4”: There are two kinematic mechanisms 34, 34′ here, which are parallel to each other in the “normal position” shown in the drawing but can be individually operated and therefore rotated relative to each other. The term “parallel” is therefore to be understood not in a mathematical sense but in a technical sense, for the individual kinematic mechanisms do not even have to be constructed the same but rather only have to be arranged “parallel” in their position between the fixed platform and the moving platform.

For each of the two kinematic mechanisms 34, 34′, the respective mounting plate 35, 35′ constitutes the (local) fixed platform; the frame of reference (inertial system), which represents the fixed platform of the parallel kinematic mechanism as a whole, is defined by the base support points of the actuators 37 and 38 and, for example, by the mounting plate 35; the mounting plate 35′ is then mounted in such a way that it can rotate about two axes with respect to this frame of reference. However, it is also possible for the plane of each planar kinematic mechanism 34, 34′, for example, defined by the plane of symmetry of the two mounting plates 35, 35′, each of which represents the fixed platform for its own mechanism, to be rotatably supported about an axis that lies in this plane or that runs parallel to this plane. In this regard, the orientation of the axes can be freely selected within wide limits; singularities are to be avoided with axes which, in possible positions of the mechanism, are parallel to the axis of the actuators; for practical reasons—increase of forces to high values—orientations that are almost parallel are also to be avoided; but this is already well known to those skilled in the art of parallel kinematic mechanisms.

Naturally, this frame of reference (that is, the fixed platform of the overall mechanism) can be movably supported, for example, in such a way that it can be rotated about a vertical axis, and is thus no longer an inertial system in the strictly physical sense, although it can continue to be regarded as such for the purposes of this specification. A moving platform 36 rests on the parallel kinematic mechanism.

The planar kinemetic mechanism 34′ is modified from the mechanisms that have been explained so far in that the actuator A′, which can be moved at its base support point, is additionally constructed as a variable-length rod. At first glance, this seems to be superfluous, since, of course, the position of the upper support point 42′ always lies on a circular path around the axis 43, and the actuator B can produce any possible movement of the upper support point via the force introduction element 49 and an actuator of fixed length. However, there are positions, specifically, when the base support points 43, 46 are far apart (flat force polygon), in which rotation of the upper support point 42′ by changing the length of the rod/actuator 45′ is advantageous from the standpoint of both the dynamics and the positional precision that can be realized.

The planar kinematic mechanism 34 does not have a “double-active” actuator of this type; an actuator A of fixed length is provided here. An actuator 37 is attached in the region of the upper support point 42 to define the position of the moving platform 36 in the direction transverse to the rotatable force polygons 34, 34′, which are (almost) parallel to each other.

Still another actuator 38 is provided for the final definition of the position of the moving platform 36. For better clarity of the drawing, the mounting devices (bearings, joints, shafts, etc.) of the individual components in the inertial system (foundation, mount, wheeled transporter, etc.) are not shown.

Here again, the good accessibility of all parts, the possibility of using standard parts as components, and the possibility of achieving a high degree of mobility are evident.

The invention is not limited to the embodiments that have been illustrated and explained. These specific embodiments demonstrate in a very general way that it is possible in an easy and clear way to arrange the kinematic mechanisms of the invention parallel to one other or serially one after the other, with suitable kinematic linkages making it possible to realize not simply doublings but rather, as explained in the examples, additional effects.

In particular, the distances between the base support points and the ratios of the lengths of the rods and actuators can be adapted to the specific necessity, which allows great variation of movements and a large number of areas of application. In combination with the properties peculiar to parallel kinematic mechanisms, such as low dead weight and high precision of movement, the invention creates a universally applicable basic unit of kinematic mechanisms.

1. A parallel kinematic mechanism with a fixed platform and a moving platform that is based on rods and actuators, where at least one actuator is designed as a rod of constant length with a base support point that can be moved relative to the fixed platform and has a common upper support point on the moving platform with a rod of constant length and fixed base support point on the fixed platform, wherein the movable base support point (6, 16, 26, 46) is guided along a circular arc by a connecting rod (7, 17, 27, 47) with a fixed base support point on the fixed platform, with which it articulates, and that an actuator (B, B1, B2) acts on the connecting rod (17, 27) or on a point of application of force (10, 40) that is rigidly connected with the connecting rod by a force introduction element (9, 49).

2. A mechanism in accordance with claim 1, wherein the connecting rod (47) has a planar or frame-like design.

3. A mechanism in accordance with claim 2, wherein the connecting rod (47), together with the force introduction element (49) has essentially the form of a triangle and that the points of application of force (6, 46; 10, 40) and the base support point (8, 48) of the connecting rod are provided in the corner regions of the triangles.

4. A mechanism in accordance with claim 1, wherein the stationary base support points (3, 4, 8) of the rods (1), of the connecting rod (7, 17, 27, 47) and of the actuator (B, B1, B2) are formed on a bearing plate (35).

5. A mechanism in accordance with claim 1, wherein the actuator (B, B1, B2) is constructed as a spindle-nut drive.

6. A marallel kinematic mechanism, which consists of two kinematic mechanisms in accordance with claim 1, wherein the first kinematic mechanism has the fixed point (14) for the actuator (B1), the fixed point (18) for the connecting rod (17) and the fixed point (13) for the rod (11), that the fixed point (24) for the actuator (B2) of the second kinematic mechanism coincides with the fixed point (13) of the first planar kinematic mechanism, and that the fixed point (28) of the connecting rod (27) as well as the fixed point (23) of the rod (21) are provided in the region of the upper support point (12) of the rod (11) of the first kinematic mechanism.

7. A combined parallel kinematic mechanism with at least two kinematic mechanisms in accordance with claim 1, arranged parallel to each other, wherein at least one of the kinematic mechanisms (34, 34′) can be rotated with respect to the stationary system of the combined parallel kinematic mechanism about an axis that runs parallel to the plane of symmetry of one of the kinematic mechanisms (34, 34′).
